(19) United States
(12) Patent Application Publication
(10) Pub. No.: US 2004/0265461 A1
(43) Pub. Date: Dec. 30, 2004

(54) Nutritional non-cultured beverage composition

(75) Inventors: Kenneth William Cale, Suffern, NY (US); Donna Maria Parker, Nanuet, NY (US); Patricia Carulli Hauser, Highland Mills, NY (US); Jean-Pierre Baril, Fishkill, NY (US); Zachary Pollack Caplan, Tarrytown, NY (US); Randolph Myers, New Haven, CT (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/609,300

(22) Filed: Jun. 27, 2003

(51) Int. Cl. A23C 1/00

(52) U.S. Cl. 426/580

(57) ABSTRACT

The present invention provides a high quality, ready-to-drink, non-cultured nutritional beverage comprising (1) a protein component, (2) an emulsified fat component, (3) a fortification component, and (4) an optional sweetener component. Preferably the protein component comprises minimally processed milk; the emulsified fat component comprises dairy fat; the beverage contains about 1.5 to 10 percent total protein and about 0.15 to about 5 percent total fat; the beverage has a first ratio of the minimally processed milk protein divided by the total protein which is greater than or equal to about 0.45; the beverage has a second ratio of the dairy fat divided by the total fat which is greater than or equal to about 0.33; and the fortification component provides at least 10 percent of the daily value per single beverage serving of at least 6 vitamins and minerals.

### FIELD OF THE INVENTION

The invention relates to a high quality, ready-to-drink, non-cultured nutritional beverage. More specifically, the present invention relates to a high quality, ready-to-drink, non-cultured nutritional beverage comprising a protein component, (2) an emulsified fat component, (3) a fortification component, and (4) an optional sweetener component.

### BACKGROUND

Nutritional or fortified beverages, especially of the ready-to-drink or consume type, have become very popular. Such products include sport or nutritional beverages, sport or nutritional gels, nutritional shakes, meal replacement beverages, and the like. Often such products possess poor, or at least less than desired, taste, mouthfeel, or other organoleptic properties. Consumers are often willing to accept such products with their inherent defects because of the nutritional benefit expected from the product. Of course, it would be desirable to provide nutritional or fortified beverages which provide the desired nutritional benefit and improved taste, mouthfeel, or other organoleptic properties.

Efforts have been made to provide such improved nutritional or fortified beverages. For example, International Application PCT/US/21303 (filed Nov. 20, 1997; published May 28, 1998) provided an improved, water-based, liquid nutritional supplement comprising (1) a macro-nutrient component containing at least one protein source, at least one fat source, and at least one carbohydrate source, (2) a mineral micro-nutrient component containing specific amounts of potassium, calcium, magnesium, phosphorus, and iron. Generally, the total solids content of the supplement was greater than 30 percent.

U.S. patent Publication 2002/0037353 (Mar. 28, 2002) describes ready-to-drink fortified beverages which reportedly provide a rich, foamy product with a clean, improved mouthfeel and thickness without sliminess and a higher flavor impact at lower solids content. This beverage comprises (A) a water-insoluble component having particles with a mean particle size diameter of from about 0.1 to about 3.0 microns which comprises: (1) from about 0.2 to about 40% of a microparticulate component; (2) from about 0.0 to about 40% of a fat/oil component; (3) from about 0.0 to about 3.0% of an emulsifier; (4) from about 0 to about 5% of a microcrystalline cellulose; (B) a water-soluble component which comprises: (1) from about 0.075 to about 40% of a soluble beverage component; (2) from about 0.05 to about 30% of a thickener; (3) from about 0 to about 4% buffers; (4) from about 0 to about 60% foam stabilizer; (5) from about 0 to about 5% acid; (6) from about 0 to about 5% carbonate/bicarbonate; (7) from about 0 to about 50% sweetener; (8) from about 0 to about 20% milk solids; (9) from about 0 to about 3% processing aids; (10) from about 0.1 to about 5% of a vitamin/mineral mix; (C) from about 0 to about 10% of a flavorant; and (D) from about 0 to about 95% water; wherein the ratio of the water-insoluble to water-soluble components in said beverage product is about 0.300 or greater.

U.S. Pat. No. 6,093,425 (Jul. 25, 2000) provided a reportedly complete nutritional dairy-based product containing at least 27 of the nutrients included on the list of nutritionally essential macro- and micro-nutrients listed in the Code of Federal Regulation (21 CFR 101.9, 1998). The organoleptic properties of the resulting products are not discussed in detail. This patent does provide a detailed compilation of the nutritional profiles of commercially available nutritional milk-based products.

The present invention provides improved ready-to-drink, non-cultured nutritional beverages. By combining high quality protein (i.e., minimally processed milk protein), high quality fat (i.e., dairy fat), fortification levels which are managed to minimize their impact of taste, and sweeteners, the present invention provides a beverage having superior quality. More specifically, the present invention provides a nutritional ready-to-drink, non-cultured beverage which provides both good taste and organoleptic properties as well as nutritional benefit.

### SUMMARY OF THE INVENTION

The present invention provides a high quality, ready-to-drink, non-cultured nutritional beverage. In one embodiment, the present invention provides high quality, ready-to-drink, non-cultured nutritional beverage comprising (1) a protein component comprising minimally processed milk protein; (2) an emulsified fat component comprising dairy fat; (3) a fortification component comprising vitamins and minerals; (4) an optional sweetener component; and (5) water; wherein the beverage contains about 1.5 to about 10 percent total protein and about 0.15 to about 5 percent total fat; wherein the beverage has a first ratio of the minimally processed milk protein divided by the total protein and wherein the first ratio is greater than or equal to about 0.45; wherein the beverage has a second ratio of the dairy fat divided by the total fat and wherein the second ratio is greater than or equal to 0.33; and wherein the fortification component provides at least 10 percent of the daily value per single beverage serving of at least 6 vitamins and minerals. In another embodiment, the present invention provides high quality, ready-to-drink, non-cultured nutritional beverage comprising (1) a protein component comprising minimally processed milk protein, dairy protein concentrate, and non-dairy protein; (2) an emulsified fat component comprising dairy fat and non-dairy fat; (3) a fortification component comprising vitamins and minerals; (4) an optional sweetener component; and (5) water; wherein the beverage contains about 1.5 to about 10 percent total protein and about 0. 15 to about 5 percent total fat; wherein the beverage has a first ratio of the minimally processed milk protein divided by the total protein and wherein the first ratio is greater than or equal to about 0.45; wherein the beverage has a second ratio of the dairy fat divided by the total fat and wherein the second ratio is greater than or equal to 0.33; and wherein the fortification component provides at least 10 percent of the daily value per single beverage serving of at least 6 vitamins and minerals.

The combination of high quality protein (primarily minimally processed milk protein), high quality fat (primarily dairy fat), control of the fortification levels (e.g., restricted levels of thiamine), and the addition of optional sweeteners allow the production of a superior quality nutritional beverage which provides both good taste and organoleptic properties as well as nutritional benefit.

### DESCRIPTION OF THE PREFERRED EMBODIMENTS

The present invention provides a high quality, ready-to-drink, non-cultured nutritional beverage. More specifically, the present invention provides high quality, ready-to-drink, non-cultured nutritional beverage comprising (1) a protein component comprising minimally processed milk protein; (2) an emulsified fat component comprising dairy fat; (3) a fortification component comprising vitamins and minerals; (4) an optional sweetener component; and (5) water; wherein the beverage contains about 1.5 to about 10 percent total protein and about 0.15 to about 5 percent total fat; wherein the beverage has a first ratio of the minimally processed milk protein divided by the total protein and wherein the first ratio is greater than or equal to about 0.45; wherein the beverage has a second ratio of the dairy fat divided by the total fat and wherein the second ratio is greater than or equal to 0.33; and wherein the fortification component provides at least 10 percent of the daily value per single beverage serving of at least 6 vitamins and minerals. The present invention also provides high quality, ready-to-drink, non-cultured nutritional beverage comprising (1) a protein component comprising minimally processed milk protein, dairy protein concentrate, and non-dairy protein; (2) an emulsified fat component comprising dairy fat and non-dairy fat; (3) a fortification component comprising vitamins and minerals; (4) an optional sweetener component; and (5) water; wherein the beverage contains about 1.5 to about 10 percent total protein and about 0.15 to about 5 percent total fat; wherein the beverage has a first ratio of the minimally processed milk protein divided by the total protein and wherein the first ratio is greater than or equal to about 0.45; wherein the beverage has a second ratio of the dairy fat divided by the total fat and wherein the second ratio is greater than or equal to 0.33; and wherein the fortification component provides at least 10 percent of the daily value per single beverage serving of at least 6 vitamins and minerals. For purposes of this invention, a single beverage serving size is about 6 to about 12 ounces.

The combination of high quality protein (primarily minimally processed milk protein), high quality fat (primarily dairy fat), control of the fortification levels (e.g., restricted levels of thiamine), and addition of optional sweeteners allow the production of a superior quality nutritional beverage which provides both good taste and organoleptic properties as well as nutritional benefit.

The protein component comprises minimally processed milk protein such that the beverage contains about 1.5 to about 10 percent total protein and has a

$$first ratio = \frac{minimally processed milk protein}{total protein}$$

which, is greater than or equal to 0.45. More preferably, this first ratio is greater than about 0.65, and even more preferably is about 0.8 to about 1. For purposes of this invention, “minimally processed milk protein” includes protein from single strength whole milk, reduced-fat milk, skim milk, and liquid or dry concentrated versions of whole milk, reduced-fat milk, or skim milk having a protein concentration, on a dry basis, similar to the starting single strength whole milk, reduced-fat milk, or skim milk. In addition to the minimally processed milk protein, the total protein may contain other types of protein, including for example, dairy protein concentrates and non-dairy proteins. For purposes of this invention, “dairy protein concentrates” include dairy protein sources containing, on a dry basis, protein concentrations greater than single strength whole milk, reduced-fat milk, or skim milk. Examples of such dairy protein concentrates include, for example, milk protein concentrates, caseinates, whey protein concentrates, and the like. For purposes of this invention, “non-dairy protein” includes, for example, soy protein, other plant proteins (e.g., wheat protein, protein from cocoa, protein from coffee, and the like), and the like.

The emulsified fat component comprises dairy fat such that the beverage contains about 0.15 to about 5 percent total fat and has a

$$second ratio = \frac{dairy fat}{total fat}$$

which is greater than about 0.33. More preferably, this second ratio is greater than about 0.67, and even more preferably is about 0.9 to about 1. Suitable dairy fats include, for example, fats obtained from or supplied from milk (whole, reduced fat, or low fat milks), heavy cream, light cream, half and half, and the like, as well as evaporated or dried version of the same. In addition to the dairy fat, the beverage may also contain other fats including non-dairy fats. Suitable non-dairy fats include, for example, vegetable oils (e.g., corn, canola, soybean, and the like), process oils (e.g., medium chain triglycerides), coconut oil, oils found in cocoa or coffee, oils from other plant sources, and the like.

As those skilled in the art will realize, the high quality protein (primarily minimally processed milk protein) and the high quality fat (primarily dairy fat) may be derived from the same dairy component or from separate dairy components. Likewise, the protein component and the emulsified fat components may be derived from the same dairy or other component or from separate dairy or other components.

Generally, the beverages of the present invention contain about 1.5 to about 10 percent total protein, about 0.15 to about 5 percent of total fat, an amount of the fortification component to provide at least six vitamins and minerals at 10 percent or more of the daily value per serving size for each of the at least six vitamins and minerals, about 0.001 to about 15 percent of the sweetener component, and about 75 to about 97 percent total water. More preferably the beverages of the present invention contain about 2 to about 4.5 percent total protein, about 0.5 to about 3.5 percent total fat, the amount of the fortification component to provide at least ten vitamins and minerals at 20 percent or more of the daily value per serving size for each of the at least six vitamins and minerals, about 0.003 to about 12 percent of the sweetener component, and about 80 to about 95 percent water.

The fortification component should provide at least 10 percent of the daily value per single beverage serving (generally about 6 to about 12 ounces) of at least 6 vitamins and minerals. More preferably, the fortification component provides at least about 20 percent of the daily value per single beverage serving of at least ten vitamins and minerals. Suitable vitamins and minerals include, for example, those listed as being nutritionally essential macro- and micro-nutrients in the Code of Federal Regulation (21 CFR 101.9 and 104.20, 2002). Suitable vitamins and minerals for use in the present invention are also included in the examples below. The beverage preferably contains less than about 4 ppm thiamine in order to reduce the adverse impact on organoleptic properties.

The sweetener component may contain natural or artificial sweeteners. Examples of such sweeteners include natural sugars such as sucrose, fructose, glucose, maltose, high fructose corn syrup, and lactose and artificial sweetening agents such as saccharin, aspartame, acesulfame potassium, and sucralose. Of course, others sweeteners normally used in food processing can be used if desired.

The following examples describe and illustrate the processes and products of the invention. These examples are intended to be merely illustrative of the present invention, and not limiting thereof in either scope or spirit. Unless indicated otherwise, all percentages and ratios are by weight. Those skilled in the art will readily understand that variations of the materials, conditions, and processes described in these examples can be used. All references cited herein are incorporated by reference.

### EXAMPLE 1

A beverage was prepared using the following formulation:

| Ingredient | % |
|---|---|
| Water | 19.9 |
| Sugar | 5.6 |
| Milk | 23.5 |
| Skim Milk | 47.4 |
| Disodium phosphate | 0.15 |
| Potassium Bicarbonate | 0.05 |
| Milk Protein Concentrate | 0.25 |
| Sodium Caseinate | 0.25 |
| Inulin | 0.7 |
| Gum Arabic | 0.7 |
| Artificial Flavor | 0.08 |
| Carrageenan | 0.02 |
| Antifoam | 0.01 |
| Microcrystalline Cellulose | 0.4 |
| Cocoa | 0.5 |
| Vitamin Premix | 0.58 |

The vitamin premix provided the following fortification levels:

| Vitamin/Mineral | Daily Value (%)* |
|---|---|
| Sodium Ascorbate (Vitamin C) | 100 |
| Biotin (Vitamin H) | 35 |
| d-Calcium Pantothenate (Vitamin B5) | 35 |
| Folic Acid (Vitamin B9) | 35 |
| Niacinamide (Vitamin B3) | 35 |
| Pyridoxine Hydrochloride (Vitamin B6) | 35 |
| Riboflavin (Vitamin B2) | 35 |
| Thiamine Mononitrate (Vitamin B1) | 15 |
| Vitamin A Pamitate | 35 |
| Cyanocobalamin (Vitamin B12) - | 35 |
| 0.1% potency | |
| Cholecalciferol (Vitamin D3) | 25 |
| Tocopheryl Acetate (Vitamin E Acetate) | 100 |
| Phytonadione (Vitamin K1) | 35 |
| Chromium (Chromium Chloride) | 35 |
| Copper (Copper Gluconate) | 15 |
| Iron (Ferric Orthophosphate) | 25 |
| Magnesium (Magnesium Phosphate) | 35 |
| Manganese (Manganese Sulfate) | 25 |
| Molybdenum (Sodium Molybdate) | 35 |
| Iodine (Potassium Iodide) | 35 |
| Selenium (Sodium Selenite) | 35 |
| Zinc (Zinc Gluconate) | 25 |
| Phosphorous (Magnesium Phosphate) | 7 |

*Based on 11 oz beverage serving size.

Three dry mix blends were prepared: Premix A—microcrystalline cellulose and sugar; Premix B—artificial flavor, buffers, vitamin/mineral premix, carageenan, gum arabic, and sugar; and Premix C—milk protein concentrate, sodium caseinate, gum arabic, inulin, cocoa, and sugar. Antifoam, and then skim milk, was added to softened water with high shear mixing. Premix A was then added and mixed for about 5 minutes. Premix B was then added with further mixing for about 10 minutes. After adding additional softened water, Premix C was added with further mixing for about 10 minutes. The remaining ingredients were then added and the resulting composition mixed until uniform.

The composition was then homogenized using a two-stage homogenizer operated at 500/2500 psi. The homogenized mixture was then heated to about 290° F. for at least 4 seconds to achieve an F₀ of about 10.6 and then cooled to 78° F. before being sealed in pre-sterilized containers (H₂O₂ treated) under aseptic conditions.

The resulting beverage delivered a high quality dairy flavor and texture with no vitamin/mineral aftertaste. The beverage contained about 2.9 percent total protein and about 0.8 percent total fat and had a first ratio of about 0.82 and a second ratio of about 0.97.

### EXAMPLE 2

A beverage was prepared using the following formulation:

| Ingredient | % |
|---|---|
| Water | 33.0 |
| Sugar | 7.0 |
| Milk | 24.6 |
| Skim Milk | 34.1 |
| Disodium phosphate | 0.15 |
| Potassium Bicarbonate | 0.05 |
| Tricalcium Phosphate | 0.13 |
| Artificial Flavor | 0.08 |
| Carrageenan | 0.02 |
| Microcrystalline Cellulose | 0.4 |
| Cocoa | 0.5 |
| Vitamin Premix | 0.58 |

The vitamin premix provided the following fortification levels:

| Vitamin/Mineral | Daily Value (%)* |
|---|---|
| Calcium | 30 |
| Cyanocobalamin (Vitamin B12) - | 15 |
| 0.1% potency | |
| Cholecalciferol (Vitamin D3) | 25 |
| Phosphorous (Magnesium Phosphate) | 25 |
| Riboflavin (Vitamin B2) | 25 |
| Vitamin A Pamitate | 10 |

*Based on 11 oz beverage serving size.

The microcrystalline cellulose and carrageenan were dispersed under high shear in water. The following ingredients were then added, in the order listed, with high shear mixing: skim milk, vitamin premix, cocoa, and buffers. The resulting composition was then blended with the remaining ingredients with heating to about 165° F. and then homogenized at about 3000 psi. The homogenized mixture was cooled to room temperature and filled into glass bottles. The bottled beverage was retorted at about 250° F. for at least 24 minutes and then cooled to below 80° F.

The resulting beverage had a rich dairy flavor with a creamy, milk-like texture. The beverage contained about 2.2 percent total protein and about 0.9 percent total fat and had a first ratio of about 0.90 and a second ratio of about 0.94.

### EXAMPLE 3

A beverage was prepared using the following formulation:

| Ingredient | % |
|---|---|
| Water | 15.0 |
| Sugar | 7.25 |
| Milk | 16.7 |
| Skim Milk | 57.1 |
| Disodium phosphate | 0.15 |
| Potassium Bicarbonate | 0.05 |
| Milk Protein Concentrate | 0.24 |
| Sodium Caseinate | 0.25 |
| Inulin | 0.75 |
| Gum Arabic | 0.7 |
| Artificial Flavor | 0.08 |
| Carrageenan | 0.02 |
| Microcrystalline Cellulose | 0.2 |
| Cocoa | 1.0 |
| Vitamin Premix | 0.58 |

The vitamin premix provided the following fortification levels:

| Vitamin/Mineral | Daily Value (%)* |
|---|---|
| Sodium Ascorbate (Vitamin C) | 100 |
| Biotin (Vitamin H) | 35 |
| d-Calcium Pantothenate (Vitamin B5) | 35 |
| Folic Acid (Vitamin B9) | 35 |
| Niacinamide (Vitamin B3) | 35 |
| Pyridoxine Hydrochloride (Vitamin B6) | 35 |
| Riboflavin (Vitamin B2) | 35 |
| Thiamine Mononitrate (Vitamin B1) | 15 |
| Vitamin A Pamitate | 35 |
| Cyanocobalamin (Vitamin B12) - | 35 |
| 0.1% potency | |
| Cholecalciferol (Vitamin D3) | 25 |
| Tocopheryl Acetate (Vitamin E Acetate) | 100 |
| Phytonadione (Vitamin K1) | 35 |
| Chromium (Chromium Chloride) | 35 |
| Copper (Copper Gluconate) | 15 |
| Iron (Ferric Orthophosphate) | 25 |
| Magnesium (Magnesium Phosphate) | 35 |
| Manganese (Manganese Sulfate) | 25 |
| Molybdenum (Sodium Molybdate) | 35 |
| Iodine (Potassium Iodide) | 35 |
| Selenium (Sodium Selenite) | 35 |
| Zinc (Zinc Gluconate) | 25 |
| Phosphorous (Magnesium Phosphate) | 7 |

*Based on 10 oz beverage serving size.

The buffers were dispersed in a portion of the water; after adding the gums, the mixture was mixed with high shear for about 5 minutes. The remaining dry ingredients were added. The resulting mixture was then slowly dispersed in the remaining water after which the mixture was subjected to high shear for about 5 minutes. The mixture was then blended with the milk and pasteurized by heating to 285° F. for about 5 seconds and then homogenized at about 2500 psi. After cooling, the resulting beverage was filled in sterile glass bottles at 65-80° F. and immediately refrigerated.

For the resulting beverage, the first ratio was about 0.8; the second ratio was about 0.94.

The product was compared with a commercial product (i.e., Ultra Slim Fast Creamy Chocolate; first ratio of about 0.84 and second ratio of about <0.1) in a taste test (approximately 100 testers). Using a scale of 1 (worst) to 9 (best), testers overwhelmingly preferred the inventive product (score 6.8) over the commercial product (score 3.6); the preference was significant at greater than 99% confidence level. This illustrates the critical nature of the fat composition, on perceived product quality.

### EXAMPLE 4

Two inventive beverages having the following formulations were prepared using the same method as in Example 1.

Amount (%)

| | Low Processed | High Processed |
|---|---|---|
| | Protein | Protein |
| Water | 17.1 | 15.3 |
| Sugar | 7.25 | 7.25 |
| Milk | 23.3 | 23.3 |
| Skim Milk | 48.8 | 48.8 |
| Disodium phosphate | 0.15 | 0.15 |
| Potassium Bicarbonate | 0.05 | 0.05 |
| Milk protein concentrate | 0.24 | 1.1 |
| Sodium caseinate | 0.25 | 1.15 |
| Soluble fiber | 0.75 | 0.75 |
| Gum Arabic | 0.7 | 0.7 |
| Artificial flavor | 0.7 | 0.7 |
| N&A flavor - vanilla | 0.05 | 0.05 |
| Carrageenan | 0.02 | 0.02 |
| Microcrystalline cellulose | 0.2 | 0.2 |
| Cocoa | 0 | 0.5 |
| Vitamin Premix (23) | 0.58 | 0.58 |
| First Ratio | 0.83 | 0.55 |
| Second Ratio | 0.96 | 0.93 |

These two inventive samples mainly differ in the amount of processed protein (i.e., sodium caseinate and milk protein concentrate).

Using the same preference scale as in Example 1, testers preferred both inventive beverages over the commercial product (i.e., Ultra Slim Fast Creamy Chocolate) tested in Example 1. However, between the two inventive beverages, testers preferred the low processed protein beverage (score 7.4) over the high processed protein beverage (score 6.2). This preference was significant at a 95% confidence level. This example illustrates the importance of the protein quality (i.e., the first ratio) on the organoleptic properties.

### EXAMPLE 5

The table below compares the inventive beverages with several commercially available nutritional beverages. Beverages produced by the present invention were organolepticly superior to the commercially available products examined.

| | | | Carnation Instant | | |
|---|---|---|---|---|---|
| | | Slim Fast Creamy | Breakfast (Creamy Milk | | |
| | Inventive | Chocolate | Chocolate | Ensure Vanilla | Boost Chocolate |
| Protein Source | minimally processed | Skim milk; sodium | Nonfat milk; complete | Sodium caseinate; soy | Milk protein concentrate |
| | milk protein comprising | caseinate | milk protein | protein isolate; whey | |
| | at least about 45% of | | | protein concentrate | |
| | total protein | | | | |
| Protein (%) | 1.5-10 | 2.9 | 3.9 | 3.6 | 4.0 |
| First Ratio | ≧0.45 | 0.84 | 0.5 | 0 | 0 |
| Fat Source | dairy fat comprising at | Canola oil; soy oil; soy | Corn oil; mono-& | High oleic safflower oil; | Canola oil; high oleic |
| | least about 33% of | lecithin; mono- & | diglycerides; skim milk | canola oil; corn oil; soy | sunflower oil; soy |
| | total fat | diglycerides; skim milk | | lecithin | lecithin |
| Fat (%) | 0.15-5 | 0.9 | 0.8 | 2.4 | 1.6 |
| Second Ratio | ≧0.33 | <0.1 | <0.1 | 0 | 0 |

What is claimed is:

1. A high quality, ready-to-drink, uncultured nutritional beverage comprising (1) a protein component comprising minimally processed milk protein; (2) an emulsified fat component comprising dairy fat; (3) a fortification component comprising vitamins and minerals; and (4) water; wherein the beverage contains about 1.5 to 10 percent total protein and about 0.15 to about 5 percent total fat; wherein the beverage has a first ratio of the minimally processed milk protein divided by the total protein and wherein the first ratio is greater than or equal to about 0.45; wherein the beverage has a second ratio of the dairy fat divided by the total fat and wherein the second ratio is greater than or equal to 0.33; and wherein the fortification component provides at least 10 percent of the daily value per single beverage serving of at least 6 vitamins and minerals.

2. The beverage as defined in claim 1, wherein the first ratio is greater than about 0.65 and the second ratio is greater than about 0.67.

3. The beverage as defined in claim 1, wherein the first ratio is about 0.8 to about 1 and the second ratio is about 0.9 to about 1.

4. The beverage as defined in claim 1, wherein the total protein is about 1.5 to about 6 percent and the total fat is about 0.5 to about 3.5 percent.

5. The beverage as defined in claim 4 further comprising about 0.001 to about 15 percent of a sweetener component.

6. The beverage as defined in claim 5, wherein the total protein is about 2 to about 4.5 percent and the sweetener component is present at about 0.003 to about 12 percent.

7. The beverage as defined in claim 1, wherein the fortification component provides at least about 20 percent of the daily value per single beverage serving of at least 10 vitamins and minerals.

8. The beverage as defined in claim 3, wherein the fortification component provides at least about 20 percent of the daily value per single beverage serving of at least 10 vitamins and minerals.

9. The beverage as defined in claim 6, wherein the fortification component provides at least about 20 percent of the daily value per single beverage serving of at least 10 vitamins and minerals.

10. A high quality, ready-to-drink, uncultured nutritional beverage comprising (1) a protein component comprising minimally processed milk protein, dairy protein concentrate, and non-dairy protein; (2) an emulsified fat component comprising dairy fat and non-dairy fat; (3) a fortification component comprising vitamins and minerals; (4) water; wherein the beverage contains about 1.5 to about 10 percent total protein and about 0.15 to about 5 percent total fat; wherein the beverage has a first ratio of the minimally processed milk protein divided by the total protein and wherein the first ratio is greater than or equal to about 0.45; wherein the beverage has a second ratio of the dairy fat divided by the total fat and wherein the second ratio is greater than or equal to 0.33; and wherein the fortification component provides at least 10 percent of the daily value per single beverage serving of at least 6 vitamins and minerals.

11. The beverage as defined in claim 10 further comprising a sweetener component.

12. The beverage as defined in claim 10, wherein the first ratio is greater than about 0.65 and the second ratio is greater than about 0.67.

13. The beverage as defined in claim 11, wherein the first ratio is greater than about 0.65 and the second ratio is greater than about 0.67.

14. The beverage as defined in claim 12, wherein the first ratio is greater than about 0.8 and the second ratio is greater than about 0.9.

15. The beverage as defined in claim 13, wherein the first ratio is greater than about 0.8 and the second ratio is greater than about 0.9.

16. The beverage as defined in claim 10, wherein the total protein is about 1.5 to about 6 percent and the total fat component is about 0.5 to about 3.5 percent.

17. The beverage as defined in claim 11, wherein the total protein is about 1.5 to about 6 percent, the total fat is about 0.5 to about 3.5 percent, and the sweetener component is present at about 0.001 to about15 percent.

18. The beverage as defined in claim 10, wherein the fortification component provides at least about 20 percent of the daily value per single beverage serving of at least 10 vitamins and minerals.

19. The beverage as defined in claim 16, wherein the fortification component provides at least about 20 percent of the daily value per single beverage serving of at least 10 vitamins and minerals.

20. The beverage as defined in claim 17, wherein the fortification component provides at least about 20 percent of the daily value per single beverage serving of at least 10 vitamins and minerals.
